(19) United States
(12) Patent Application Publication
(10) Pub. No.: US 2009/0073506 A1
(43) Pub. Date: Mar. 19, 2009

(54) METHOD OF SETTING SCANNER-CONTROLLING INPUT SIGNAL AND DISPLAY APPARATUS APPLIED WITH THE SAME

(75) Inventor: Kyu-Bum Han, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/055,157

(22) Filed: Mar. 25, 2008

(30) Foreign Application Priority Data
Sep. 17, 2007 (KR) 10-2007-0094319

(51) Int. Cl. H04N 1/04

(52) U.S. Cl. 358/474

(57) ABSTRACT

A scanner having a linear driving property and a scanning display apparatus using the scanner are disclosed. More particularly, a method of setting an input signal controlling a scanner can include measuring a driving property of the scanner; computing a driving property function according to the driving property; computing an inverse function of the driving property function; determining an index of an input signal corresponding to a node within a display picture based on the inverse function, the input signal being the signal controlling an angle of the scanner, and the node partitioning the display picture by a same distance in a scanning direction; and generating and storing an input signal reference table related to the relationship between the node and the index.

### CROSS-REFERENCE TO RELATED APPLICATION

This application claims the benefit of Korean Patent Application No. 10-2007-0094319, filed on Sep. 17, 2007, in the Korean Intellectual Property Office, the disclosure of which is incorporated herein in its entirety by reference.

### BACKGROUND

1. Field of the Invention

The present invention relates to a scanner driving apparatus, more specifically to a scanner having a linear driving property and a scanning display apparatus using the same.

2. Background Art

While a conventional digital information processing method is impossible to process a large amount of data in real-time, an optical signal processing method can generally perform high-speed processing, parallel processing and large data amount processing. Also, studies on designs and manufactures of a binary phase filter, an optical logic gate, a light amplifier, a photoelectric element and an optical modulator by applying a spatial light modulation method are being developed. Particularly, the optical modulator is used in an optical memory, a light display, a printer, an optical interconnection and a hologram. A light beam scanning device using the optical modulator is being developed.

The light beam scanning device functions as forming a picture image by scanning a light beam in an image forming device such as a laser printer, an LED printer, an electronic photocopier, a word processor and a projector and spotting the light beam on a photosensitive medium.

As a projection television has been recently developed, the light beam scanning device is used as means scanning a beam of light to a video display.

FIG. 1 illustrates a display apparatus using an optical modulator and a scanner. The display apparatus, illustrated in FIG. 1, includes a light source 10, a processor 20, a scanner 30 and a screen 40. Here, although the light source 10, for example, a projector, is not necessary to employ an optical modulator, the below description will be based on the projector using the optical modulator.

The light source 10, which includes the optical modulator, generates a beam of light modulated by the optical modulator. Here, the light source 10 emits the modulated beam of light in a form of a line-beam. The modulated beam is condensed on a rotation axis of the scanner 30 and is scanned on the screen 40 by the scanner 30, to thereby realize a two or three-dimensional video as a display picture. Alternatively, the light source 10 can be embodied as a laser or a laser diode. At this time, the light source 10 is turned on or off according to the driving control of the processor 20 so as to generate a laser beam. The laser beam, emitted from the light source 10, is condensed on the rotation axis of the scanner 30.

The processor 20 controls the operation of the light source 10 and the driving of the scanner 30.

The scanner 30, which is operated by the driving control of the processor 20, rotates left and right based on the rotation axis at a predetermined speed when the scanner is driven. Here, the scanner 30, illustrated in FIG. 1, is assumed to be a galvano mirror capable of rotating in two directions (i.e., clockwise and counterclockwise). The scanner 30, however, can be a polygon mirror or a rotation bar, which rotates in a single direction.

The scanner 30, which includes a motor (not shown) capable of rotating in two directions, scans the modulated beam of light, rotated by the motor and incident, to the screen 40.

FIG. 2 illustrates a beam of light, projected from a scanner, to a screen.

If the scanner 30 is placed on a position A, a modulated beam of light is projected to a position A′ of the screen 40. If the scanner 30 is replaced on a position B, the modulated beam is projected to a position B′.

The scanner 30 rotates in two directions, for example, from the position A to the position B and from the position B to the position A so as to display a display picture on the screen 40. The modulated beam corresponding to a linear video from the optical modulator is scanned left and right on the screen 40 by the two-directional rotation, to thereby form the display picture.

As described above, in a scanning method through the two-dimensional scan or the single directional scan, it is preferable that an angle is linearly determined for a scanner control signal (i.e., a driving voltage or a driving current), supplied to the scanner 30, as an ideal method.

However, the linear property of a signal to an angle is not able to be satisfied one hundred percent due to machine errors of the scanner 30 and errors of processor and sensor. Also, if every scanner 30 has indigenous property differences, the output property (i.e., angle property) of a scanner control signal, which is set in a form of the same driving wave type, can be varied depending on each scanner

The linearity issue is a very important factor to realize high-quality of picture in the scanning display apparatus using the foregoing scanning method. In the case of acquiring no linearity, a problematic phenomenon such as blurring or color mismatch occurs in the display picture.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a method of setting an input signal controlling a scanner for acquiring the linearity of an angle of the scanner.

Also, the present invention provides a scanning display apparatus to prevent the blurring or color mismatch of a screen from occurring by acquiring the linearity of an angle of a scanner.

According to an aspect of the present invention, there is provided a method of setting an input signal controlling a scanner, including measuring a driving property of the scanner; computing a driving property function according to the driving property; computing an inverse function of the driving property function; determining an index of an input signal corresponding to a node in a display picture based on the inverse function, the input signal controlling an angle of the scanner, the node partitioning the display picture by a same distance in a scanning direction; and generating and storing an input signal reference table related to the relationship between the node and the index.

The driving property function can show the relationship between the input signal of the scanner and the angle of the scanner.

In the meantime, the driving property function is a monotone function.

Also, the input signal reference table can be generated by determining an index of the input signal by use of a linear interpolation method for an area between nodes, the index of which is determined.

The scanner can be a two-directional type, and each of the steps can be performed for a forward direction and a reverse direction.

According to another aspect of the present invention, there is provided a scanning display apparatus including a light source, emitting a linear video successively; a scanner, scanning the linear video and realizing a display picture; and a processor, receiving a video signal and outputting an input signal controlling an angle of the scanner according to the video signal and an input signal reference table, whereas the input signal reference table is a reference table (LUT) related to the relationship of indexes of the input signal corresponding to nodes partitioning the display picture by a same distance.

The input signal reference table can be a reference table related to the relationship between the node and the index based on an inverse function of a driving property function to which a driving property of the scanner is applied. Here, the driving property function can show the relationship between the input signal of the scanner and the angle of the scanner. On the other hands, the driving property function is a monotone function.

The scanner can be a two-directional type, and the processor can refer to the input signal reference table for a forward direction and a reverse direction independently.

Also, the light source can include an optical modulator emitting a beam of light modulated from an incident beam of light, whereas the modulated beam of light can be the linear video. The optical modulator can include a plurality of micro mirrors, modulating the incident beam of light; and driving means, driving the micro mirror up and down by an applied driving voltage, whereas one micro mirror can correspond to one pixel of the display picture, and the processor supplies to the driving means the driving voltage corresponding to the video signal.

In the meantime, the method of setting an input signal controlling a scanner can be performed and stored in a recorded medium recorded with a program for executing a method in a computer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a display apparatus using an optical modulator and a scanner;

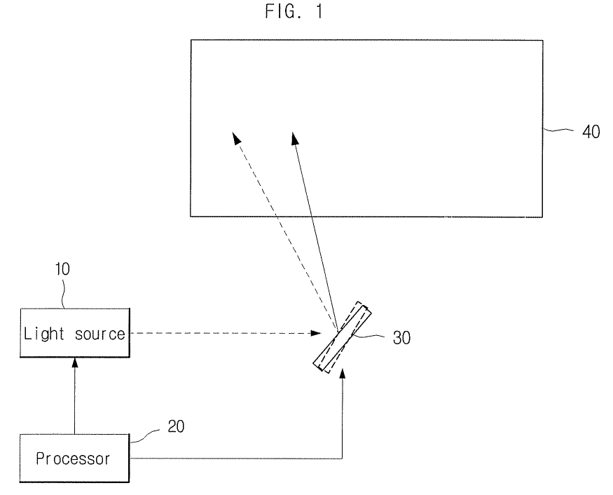

FIG. 2 illustrates a beam of light projected from a scanner to a screen;

FIG. 3 illustrates a display picture showing a linear output property of a scanner in accordance with an embodiment of the present invention;

FIG. 4 illustrates a display picture having low-level linearity of the output properties of a scanner;

FIG. 5 is a flow chart illustrating a method of setting an input signal of a scanner in accordance with an embodiment of the present invention;

FIG. 6 illustrates a linear node according to a scan time;

FIG. 7 is a graph showing the relationship between a scan time and a node;

FIG. 8 is a graph showing an angel according to a scan time;

FIG. 9 is a graph of an output property function of an angle measured according to a node;

FIG. 10 is a graph of an inverse function of the output property function illustrated in FIG. 9;

FIG. 11 is a block diagram illustrating a portable electronic apparatus in accordance with an embodiment of the present invention;

FIG. 12 is a block diagram illustrating a display apparatus processor of a projection display module;

FIG. 13 is a 3-dimensional perspective view showing an optical modulator having a plurality of micro-mirrors;

FIG. 14 is a plan view showing an optical modulator having a plurality of micro-mirrors illustrated in FIG. 2; and

FIG. 15 a schematic view of a screen generated with an image by an optical modulator applicable to an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

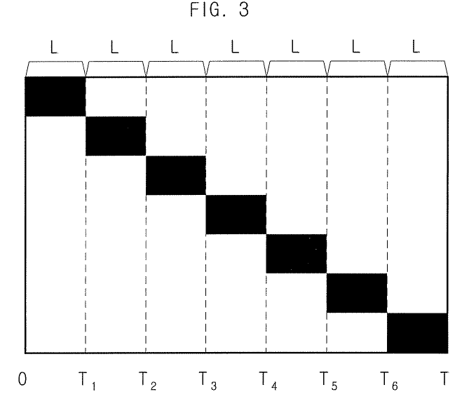

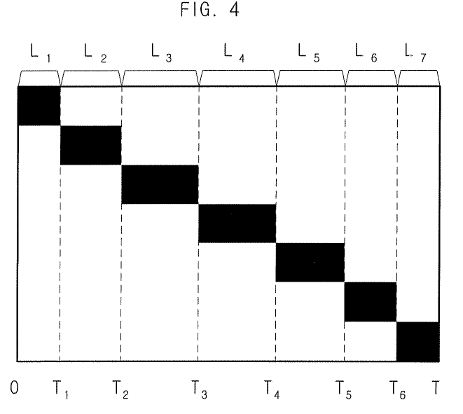

FIG. 3 illustrates a display picture showing a linear output property of a scanner in accordance with an embodiment of the present invention, and FIG. 4 illustrates a display picture having low-level linearity of the output properties of a scanner.

One video frame on a screen can be partitioned by an identical distance through a scanner. For example, the time T of scanning a display picture can be distinguished by a same interval T₁, T₂, T₃, T₄, T₅, and T₆.

A control signal allowing black quadrangles having the same horizontally directional length to successively be displayed can be supplied to the scanner. In this case, if the scanner has the linear output property, as illustrated in FIG. 3, the quadrangles having the same horizontally directional length L can be successively displayed.

If the scanner has the non-linear output property, as illustrated in FIG. 4, the quadrangles having the different horizontally directional lengths can be successively displayed. This means that although the time intervals are identical to each other, the displayed quadrangles can have different horizontally directional lengths L1, L2, L3, L4, L5, L6 and L7, respectively. This is because when a modulated beam of light is scanned to the screen, the modulated beam is not able to be scanned in an area having the same length during the same period of time.

Accordingly, in the present invention, the method of setting a scanner control signal to allow a video scanned through the scanner during the same period of time to have the linearity as illustrated in FIG. 3 and the scanner and the scanning display apparatus applied with the method will be described.

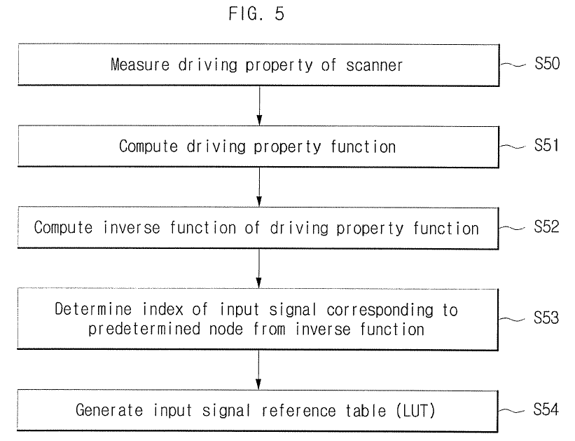

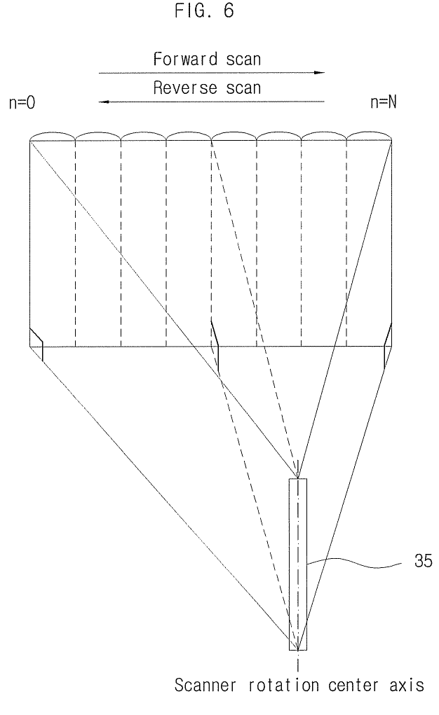

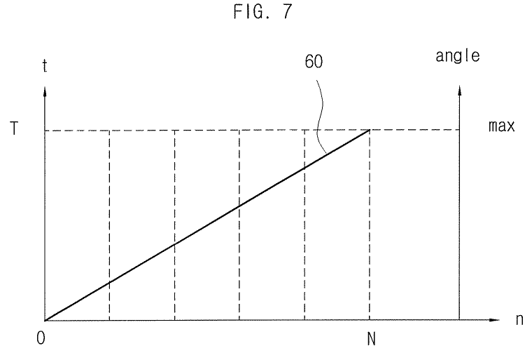

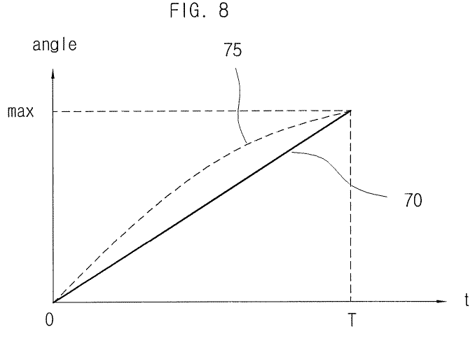

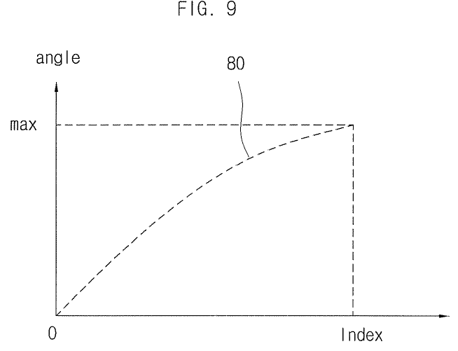

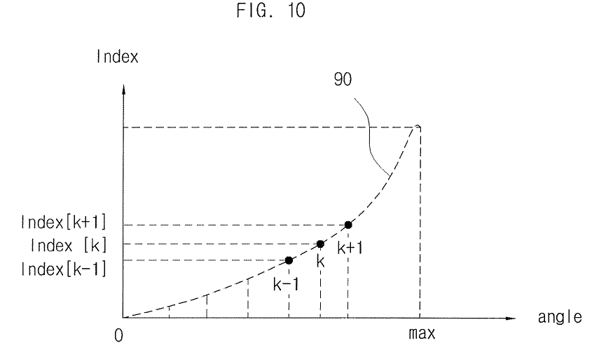

Firstly, the method of setting an input signal controlling a scanner will be described with reference to the related drawings. FIG. 5 is a flow chart illustrating a method of setting an input signal of a scanner in accordance with an embodiment of the present invention, FIG. 6 illustrates a linear node according to a scan time, FIG. 7 is a graph showing the relationship between a scan time and a node and FIG. 8 is a graph showing an angel according to a scan time. FIG. 9 is a graph of an output property function of an angle measured according to a node, and FIG. 10 is a graph of an inverse function of the output property function illustrated in FIG. 9.

A step represented by S50 selects a scanner, where the linearity of an angle is desired to be compensated, and measures the relationship between an input signal of the scanner and the angle by using an output measurement device. Then, a step represented by 51 computes a driving property function. Alternatively, a driving speed can be measured instead of the angle in order to recognize a driving property of the scanner. The device of measuring an output can be a laser vibrometer, for example.

Nodes n (n=0, 1, . . . and N) can have the linearity relationship with a scan time in a display picture which is realized as a linear video, incident into a rotation center axis of the scanner and then reflected toward the screen, is scanned (referring to FIG. 6).

N+1 nodes between 0 and N can be partitioned by a same distance. If the overall scan time is defined as t (t=0, 1, . . . and T) and the scan time t is distinguished by a same interval, the relationship between n and t can be represented as a linear function 60 illustrated in FIG. 7.

In this case, if the output property function is ideally scanned in a scan section, the angle shows an ideal output graph 70 (referring to FIG. 8). However, in case that the output property loses the linearity due to an error in a manufacturing process of the scanner or aging, the angle shows a real output graph 75. Even though FIG. 8 illustrates the real output graph 75 has the larger angle than the ideal output graph 70 at all scan times, it is obvious that the real output graph 75 can have the smaller angle in all scan times or the larger angle in a certain scan time and the smaller angle in other scan times than the ideal output graph 70.

The reason that the angle of the scan time shows the non-linear graph like the real output graph 75 of the FIG. 8 is because the input signal is linearly supplied according to the scan time t but the corresponding angle is non-linearly outputted. Here, the input signal is represented in units of index and the index indicates a DAC output level, which is a voltage or current level.

The driving property of the scanner, measured by the output measurement device can be represented as the following formula.

angle=F1(Index) [Formula 1]

Here, the index, which is the unit of the input signal, indicates a DAC output level (i.e., a voltage or current level), and the angle indicates the angle of the scanner.

The graph by the formula 1, which has the index as an independent variable and the angle as a dependent variable, can be the same as the graph 80 of FIG. 9. The function by the graph, which is a monotone increasing function, can further have corresponding inverse function.

Accordingly, a step represented by S52 computes the inverse function after computing the driving property function. The inverse function of the driving property function can be represented as the following formula 2. The inverse function can be computed by using an analytic method or a finite difference method.

Index=F2(angle)=F1⁻¹(angle) [Formula 2]

The inverse function F2 having the angle as an independent variable and the index as a dependent variable can be represented as the graph 90 of FIG. 10.

A step represented by S53 computes the index of the inverse function F2 for each of the N+1 nodes partitioning the display picture by a same distance. Each node can be represented as the angle. The index can be computed by using F12 for each angle. This can be shown in the following Table 1.

TABLE 1

| n | angle | Index |
|---|---|---|
| 0 | min | F2(min) |
| 1 | min + (max − min)/N | F2(min + (max − min)/N) |
| 2 | min + 2 * (max − min)/N | F2(min + 2 * (max − min)/N) |
| . . . | . . . | . . . |
| N | min + N * (max − min)/N | F2(min + N * (max − min)/N) |

Referring to FIG. 10, the angles angle (k−1), angle (k) and angle (k+1) corresponding to the successive nodes k−1, k and k+1 (here, k is a natural number and 0<k<N) can maintain the same distances. However, the corresponding index(k−1), index(k) and index(k+1), which are computed by the inverse function F2, can have different distances by applying the non-linear output property of the scanner.

In other words, since the index of the input signal is non-linear for the scan time and the non-linear driving property of the scanner is applied, the linear scan can be allowed to be performed in the finally outputted display picture.

Here, in the case of partitioning the display picture by a same distance by using the N+1 nodes, the larger N can lead to more improved precision. The resolving power R of the scanner can be smaller than N. Here, the resolving power of the scanner can be the number of linear videos, reflected from the scanner and displayed in the screen, when forming the display picture.

The index of the input signal can be determined according to the foregoing Table 1 for the N+1 nodes. For R−N−1 points between each node, the index of the input signal can be computed by a linear interpolation method.

A step represented by S54 generates and stores an input signal reference table LUT for the index of the input signal of the N+1 nodes or for the index of the input signal of R points corresponding to the resolving power of the scanner.

After that, in the case of attempting to drive the corresponding scanner, the input signal by the result from the reference to the input signal reference table, generated in the step represented by S54, can be allowed to be transferred to a scanner driver and the scanned display picture can be allowed to indicate the linear output property.

In a single directional scanner, one input signal reference table is generated. However, a two directional scanner can lead to two input signal reference tables of a forward direction and a reverse direction, respectively.

The method of setting the input signal controlling the aforementioned scanner is applicable to the scanning display apparatus.

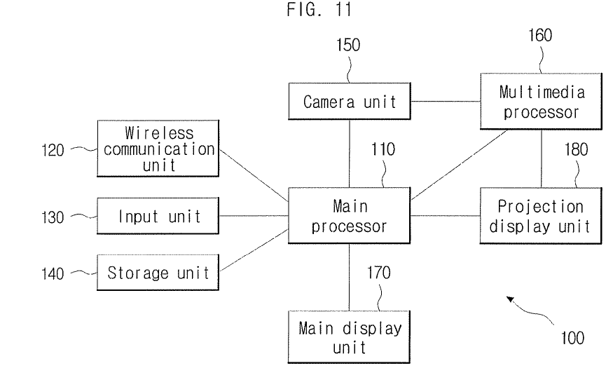

FIG. 11 is a block diagram illustrating a portable electronic apparatus in accordance with an embodiment of the present invention. The portable electronic apparatus 100, illustrated in FIG. 11, can include a main processor 110, a wireless communication unit 120, an input unit 130, a storage unit 140, a camera unit 150, a multimedia processor 160, a main display unit 170 and a projection display module 180. The projection display module 180, as described above, can be a scanning display apparatus which sets the input signal to indicate the linear output property.

The main processor 110 can control a general operation of the portable electronic apparatus 100. For example, if the input unit 130 generates and transmits to the main processor 110 a signal corresponding to user's selection, the main processor 110 can receive the signal and control each functional unit (e.g., the camera unit 150) of the portable electronic apparatus 100 to perform corresponding operations.

In particular, the main processor 110 can activate the projection display module 180 and transmit video data (e.g., image data such as JPEG and BMP) and moving picture data (e.g., MPEG and AVI) to the projection display module 180. At this time, the input unit 130 can generate a signal for activating the projection display module 180 (hereinafter, referred to as a ‘projection display module activation command’) by user's selection. Also, the video data can be stored in the storage unit 140 or can be directly transmitted from the camera unit 140 to the main processor 110 (at this time, the video data can be represented in a form of raw data before encoded in a predetermined method). For example, while the projection display module 180 is activated, if a signal for outputting certain video data stored in the storage unit 140 (hereinafter, referred to as a ‘video data output command’ and at this time, the signal can be generated corresponding to user's selection by the input unit 130) is transmitted, the main processor 110 can read the corresponding video data from the storage unit 140 and transmit the video data to the projection display module 180. Of course, it is obvious that the main processor 110 can transmit the video data to the main display unit 170 as well. At this time, the main processor 110 can generate a video data display command and transmit video data and the video data display command together or successively. The video data display command can include the projection display module activation command and video data information related to a frame forming one screen. For example, the video data information can include information related to the light intensity of red, green and blue colors of pixels in a quantity as many as the pixel number of a vertical scanning line multiplied by the pixel number of a horizontal scanning line.

The main processor 110 can correct the video data in advance before the video data is outputted to the main display unit 170 and/or the projection display module 180. For example, the main processor 110 can correct at least one of size, color, pixel and resolution of the video data to be outputted corresponding to a signal for correcting the video to be outputted (hereinafter, referred to as a ‘video correction command’) and then can transmit the corrected video data to the projection display module 180. At this time, the video correction command can be the signal, which has been generated by the input unit 130 according to user's selection and transmitted to main processor 110.

If the portable electronic apparatus 100 includes no multimedia processor 160, the main processor 110 can control a multimedia function. For example, the main processor 110 can control all operations, including activation, of the camera unit 150.

The wireless communication unit 120 can perform a wireless communication function. For example, if the wireless communication unit 120 is in a wireless communication mode, the wireless communication unit 120 can transmit inputted sound and/or data signals (e.g., moving picture data, picture data and short message service (SMS) data) to the main processor 110 by decoding the signals in a predetermined method or can transfer the sound and/or picture signals, inputted through the main processor 110, to an outside by encoding the signals in a predetermined method.

The input unit 130 can generate and transmit to the main processor 110 a signal corresponding to user's selection. Particularly, the input unit 130 can generate the projection display module activation command, the video data output command and/or the video correction command, for performing the forgoing functions, and transmit the commands to the main processor 110. The input unit 130 can employ a key pad and/or a touch pad, for example.

The storage unit 140 can store all kinds of data used in the portable electronic apparatus 110, particularly video data. For example, video raw data inputted through the camera unit 150 can be encoded by the main processor 110 and/or the multimedia processor 160 and stored by the storage unit 140. The main processor 110 can read the previously stored video data.

The camera unit 150 can generate video raw data by converting a video signal, inputted from an outside, into an electric signal and transmit the electric signal to the main processor 110 and/or multimedia processor 160. At this time, the main processor 110 can control the inputted video raw data to be displayed through the main processor 170 and/or the projection display module 180.

The multimedia processor 160 can control all kinds of multimedia functions (e.g., MP3 file replaying and camera) of the portable electronic apparatus 100. For example, the multimedia processor 160 can decode the inputted video data or encode the video raw data. However, it shall be obvious that the portable electronic apparatus 100 can be realized to allow the main processor 110 to perform the functions of the multimedia processor 160 without being equipped with the multimedia processor 160.

The main display unit 170 can output all kinds of functions of the portable electronic apparatus 100 so as to be recognized by a user. For example, the video data corresponding to the video data output command can be processed by the main processor 110 and outputted to the outside through the main display unit 170. The main display unit 170 can use a liquid crystal display (LCD).

The projection display module 180 can also output all kinds of functions of the portable electronic apparatus 100 so as to be recognized by the user. The projection display module 180 can be operated independently or together with the main display unit 170.

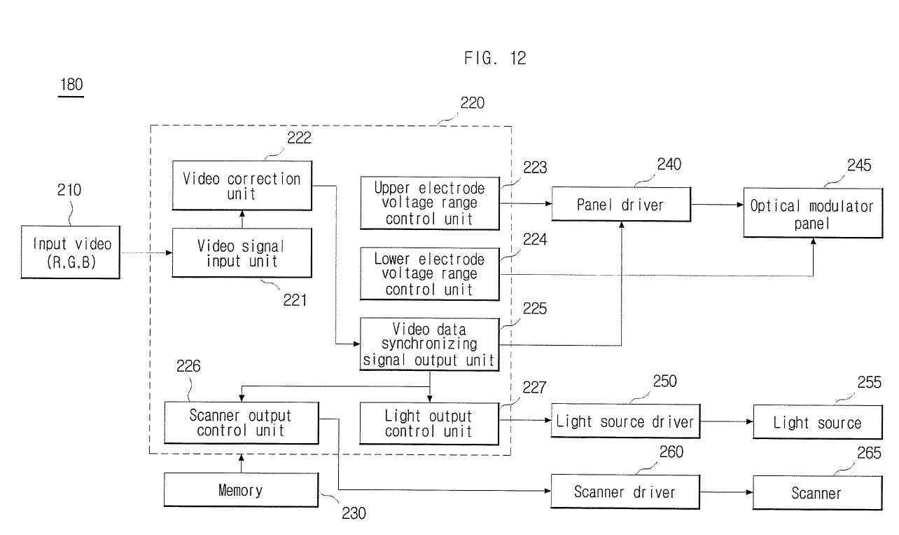

FIG. 12 is a block diagram illustrating a display apparatus processor 220 of a projection display module 180.

Referring to FIG. 12, a video signal can be inputted into a video signal input unit 221 of the display apparatus processor 220. Here, the video signal input unit 221 can transfer the video signal to a video correction unit 222. The video signal can include R, G and B digital data and a timing signal. Then, the video correction unit 222 can correct the received video signal according to the property between each element or correct the corresponding color property. Here, the video correction unit 222 can be connected to a memory 230 to read an initial setting value and then can perform a correction process by a correction logic. Also, while stored in the memory 230, the input signal reference table can be referred by a scanner output processor 226 as described above.

A video data synchronizing signal output unit 225 can vertically pivot a video signal of a raster scan direction and transfer a frame synchronizing signal, a pixel synchronizing signal and a vertical line output timing signal to a panel driver 240.

The panel driver 240 can convert digital video data into an analog signal for driving a panel and can be synchronized with the vertical line output timing signal to drive an optical modulator panel 245. Further, the panel driver 240 can match a video gradation and an output voltage level to each other by referring to an analog voltage range determined by an upper electrode voltage range adjusting unit 223.

The optical modulator panel 245, which includes an optical modulator, can modulate the amount of diffracted light, incident from a light source 255, by generating machinery transformation by difference in relative voltages between the upper and lower electrodes (a voltage is supplied by a lower electrode voltage control unit 224).

A scanner output control unit 226 can be synchronized to the vertical line output timing signal and output a position control signal of a scanning device 265 to a scanner driver 260. A light output control unit 227, which is synchronized to the a video synchronizing signal, can output a light source control signal so as to successively output red, green and blue beams of light and transfer the light source control signal to a light source driver 250 driving a light source 255. The memory 230 can store a correction value of the video correction unit 222 (per pixel and color), an upper electrode voltage range, an initial setting value of a lower electrode voltage, a scanner profile and a light output setting value.

Here, the scanner output control unit 226 can determine the index of an input signal according to a scan time by referring to an input signal reference table stored in the memory 230 and provide the determined index to a scanner driver 260. The scanner driver 260 can control the position of a scanner 265 by performing the analog-converting of the inputted index and providing it to the scanner 265.

In the present invention, the optical modulator, which includes the optical modulator panel 245, can modulate a beam of light by a method controlling on/off of the beam of light or using reflection/diffraction. The method using the reflection/diffraction can be divided into an electrostatic type and a piezoelectric type. Although the below description is based on the piezoelectric type, the same description can be applied to the electrostatic type.

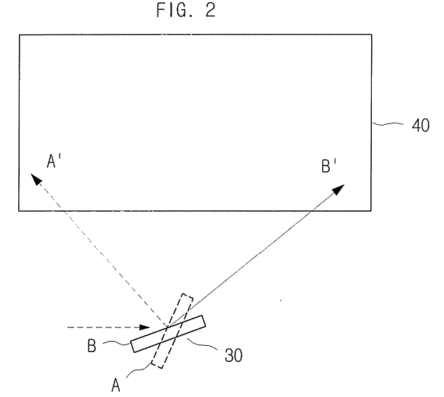

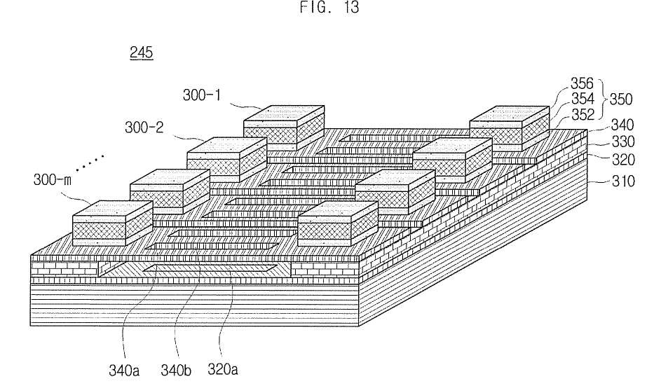

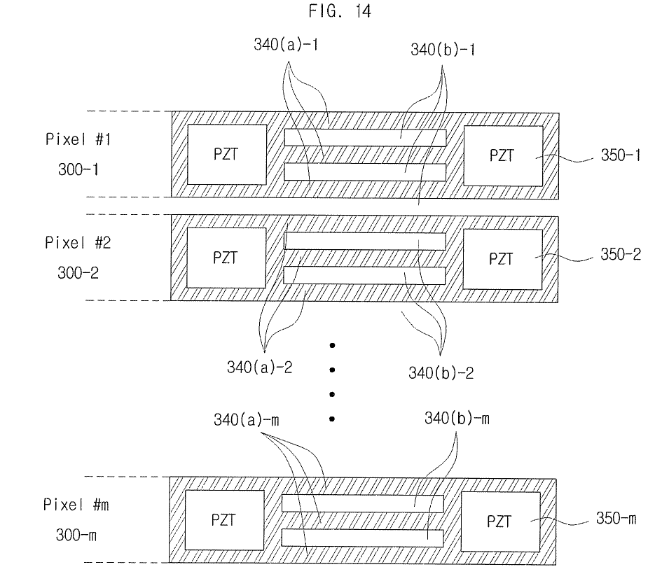

A micro mirror included in an optical modulator having an open hole structure is in FIG. 13 and FIG. 14. FIG. 13 is a 3-dimensional perspective view showing an optical modulator having a plurality of micro-mirrors, and FIG. 14 is a plan view showing an optical modulator having a plurality of micro-mirrors illustrated in FIG. 2. In an embodiment of the present invention, one micro mirror is assumed to deal with one pixel.

The micro mirror 300-1, 300-2, . . . and 300-m (hereinafter, collectively referred to as 300) can include a substrate 310, an insulation layer 320, a sacrificial layer 330, a ribbon structure 340 and a piezoelectric element 350.

The insulation layer 320 can be layered on the substrate 310. There can be provided the sacrificial layer 330 allowing the ribbon structure 340 to be spaced at a predetermined interval from the insulation layer 320. The ribbon structure 340 can create interference in an incident beam of light in order to perform optical modulation of signals. The ribbon structure 340 can be structured to include a plurality of open holes 340b in a center area thereof. Here, although the open holes 340b are illustrated to have long rectangular shape in a lengthwise direction of the micro mirror 300, the open holes 340b can have various shapes such as a circle and an ellipse. Alternatively, a plurality of open holes 340b having the long rectangular shape can be arranged in parallel in a direction of the width of the micro mirror 300.

The piezoelectric element 350, which is configured to include a lower electrode 352, a piezoelectric layer 354 and an upper electrode 356, can control the ribbon structure 340 to move upwardly and downwardly according to upward and downward, or leftward and rightward contraction or expansion levels generated by the difference in voltage between the upper and lower electrodes. Here, a lower reflective layer 320a can be formed in correspondence with the open holes 340b formed in the ribbon structure 340 or can be formed in an overall area of the insulation layer 320.

For example, in case that the wavelength of a beam of light is λ, a first voltage, which allows the gap between an upper reflective layer 340a formed in the ribbon structure 340 and the lower reflective layer 320a formed in the insulation layer 320 to be (21)λ/4, 1 being a natural number, can be supplied to the piezoelectric element 350. Accordingly, in the case of a 0^{th}-order diffracted beam of light, the overall path length difference between the light reflected by the upper reflective layer 340a and the light reflected by lower reflective layer 320a is equal to 1λ, so that constructive interference occurs and the diffracted light renders its maximum luminance. In the case of the +1^{st} or −1^{st} order diffracted light, however, the luminance of the light is at its minimum value due to destructive interference.

Also, a second voltage, which allows the gap between the upper reflective layer 340a formed in the ribbon structure 340 and the lower reflective layer 320a formed in the insulation layer 320 to be (21+1)λ/4, 1 being a natural number, can be supplied to the piezoelectric element 350. Accordingly, in the case of a 0^{th}-order diffracted beam of light, the overall path length difference between the light reflected by the upper reflective layer 340a and the light reflected by lower reflective layer 320a is equal to (21+1)λ/2, so that destructive interference occurs and the diffracted light renders its minimum luminance. In the case of the +1^{st} or −1^{st} order diffracted light, however, the luminance of the light is at its maximum value due to constructive interference.

As a result of these interferences, the micro mirror can load a signal of one pixel on a beam of light by adjusting the amount of the diffracted light. Although the foregoing describes the cases in which the gap between the ribbon structure 340 and the insulation layer 320 is (21λ)/4 or (21+1)λ/4, the luminance of the light interfered by the diffraction and/or reflection can be controlled by adjusting the gap between the ribbon structure 340 and the insulation layer 320. The modulated beam of light can include a 0^{st} order diffracted light and +n^{th} and −n^{th} order diffracted light, n being a natural number.

The optical modulator can be configured to include m micro-mirrors 100-1, 100-2, . . . , and 100-m, each of which corresponds to a first pixel (pixel #1), a second pixel (pixel #2), . . . , and an m′ h pixel (pixel #m), respectively, m being a natural number. The optical modulator deals with image information with respect to 1-dimensional images of vertical or horizontal scanning lines (which are assumed to consist of m pixels), while each micro-mirror 100 deals with one pixel among the m pixels constituting the vertical or horizontal scanning line. Accordingly, the light reflected and/or diffracted by each micro-mirror is later projected as a 2 or 3-dimensional image to a screen by an optical scanning device.

As illustrated in FIG. 13 and FIG. 14, even if the above description is based on the optical modulator having the open hole structure, where one micro mirror deals with one pixel due to including a open hole, a plurality of micro mirrors can deal with one pixel. Alternatively, the optical modulator without including the open hole can use the path length difference of the reflected light according to height difference between an odd-numbered mirror and an even-numbered mirror of a plurality of micro mirrors. Beside that, a person of ordinary skill in the art must understand that various shapes of the optical modulator can be applied to the present invention.

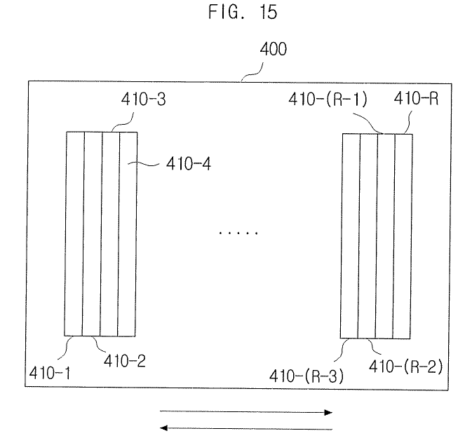

FIG. 15 a schematic view of a screen generated with an image by an optical modulator applicable to an embodiment of the present invention.

Beams of light reflected and/or diffracted by m vertically arranged micro-mirrors 300-1, 300-2, . . . , and 300-m can be reflected by an optical scanning device and then scanned horizontally onto a screen 400, to thereby generate pictures 410-1, 410-2, 410-3, 410-4, . . . , 410-(R-3), 410-(R-2), 410-(R-1), and 410-R. Here, R refers to the resolving power of a scanner. One image frame can be projected in the case of one rotation of the optical scanning device. Here, although the scanning is performed from the left to the right (i.e., the arrow indicating the direction), it is apparent that images can be scanned in another direction (e.g., in the opposite direction).

The present invention can be applied to a display apparatus having linear diffractive optical modulator. A portable electronic apparatus having various multimedia functions (e.g., a mobile phone, a personal digital assistance (PDA) and a notebook) can apply the present invention in order to reduce power consumption in a mobile display apparatus, which additionally includes a projection display module.

On the other hand, the method of setting an input signal controlling a scanner can be realized as a program. Codes and code segments of the program can be easily inferred by a computer programmer of ordinary skill in the art. Also, the program can be stored in a computer readable media, and can be read and executed by a computer, to thereby realize a document search service providing method. The computer readable media can include a magnetic recording media, an optical recording media and a carrier wave media.

Although some embodiments of the present invention have been described, anyone of ordinary skill in the art to which the invention pertains should be able to understand that a very large number of permutations are possible without departing the spirit and scope of the present invention and its equivalents, which shall only be defined by the claims appended below.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of setting an input signal controlling a scanner, the method comprising:
measuring a driving property of the scanner;
computing a driving property function according to the driving property;
computing an inverse function of the driving property function;
determining an index of an input signal corresponding to a node in a display picture based on the inverse function, the input signal controlling an angle of the scanner, the node partitioning the display picture by a same distance in a scanning direction; and
generating and storing an input signal reference table related to the relationship between the node and the index.

2. The method of claim 1, wherein the driving property function shows the relationship between the input signal of the scanner and the angle of the scanner.

3. The method of claim 1, wherein the driving property function is a monotone function.

4. The method of claim 1, wherein the input signal reference table is generated by determining an index of the input signal by use of a linear interpolation method for an area between nodes, the index of which is determined.

5. The method of claim 1, wherein the scanner is a two-directional type, and each of the steps are performed for a forward direction and a reverse direction.

6. A scanning display apparatus comprising:
a light source, emitting a linear video successively;
a scanner, scanning the linear video and realizing a display picture; and
a processor, receiving a video signal and outputting an input signal controlling an angle of the scanner according to the video signal and an input signal reference table,
whereas the input signal reference table is a reference table (LUT) related to the relationship of indexes of the input signal corresponding to nodes partitioning the display picture by a same distance.

7. The apparatus of claim 6, wherein the input signal reference table is a reference table related to the relationship between the node and the index based on an inverse function of a driving property function to which a driving property of the scanner is applied.

8. The apparatus of claim 7, wherein the driving property function shows the relationship between the input signal of the scanner and the angle of the scanner.

9. The apparatus of claim 7, wherein the driving property function is a monotone function.

10. The apparatus of claim 6, wherein the scanner is a two-directional type, and
the processor refers to the input signal reference table for a forward direction and a reverse direction independently.

11. The apparatus of claim 6, wherein the light source comprises an optical modulator emitting a beam of light modulated from an incident beam of light,
whereas the modulated beam of light is the linear video.

12. The apparatus of claim 11, wherein the optical modulator comprises:
a plurality of micro mirrors, modulating the incident beam of light; and
driving means, driving the micro mirror up and down by an applied driving voltage,
whereas one micro mirror corresponds to one pixel of the display picture, and
the processor supplies to the driving means the driving voltage corresponding to the video signal.

13. A recorded medium recorded with a program for executing a method in accordance with claim 1 in a computer, the recorded medium being readable by a computer.

14. A recorded medium recorded with a program for executing a method in accordance with claim 2 in a computer, the recorded medium being readable by a computer.

15. A recorded medium recorded with a program for executing a method in accordance with claim 3 in a computer, the recorded medium being readable by a computer.

16. A recorded medium recorded with a program for executing a method in accordance with claim 4 in a computer, the recorded medium being readable by a computer.

17. A recorded medium recorded with a program for executing a method in accordance with claim 5 in a computer, the recorded medium being readable by a computer.
